(19) United States
(12) Patent Application Publication
(10) Pub. No.: US 2002/0186769 A1
(43) Pub. Date: Dec. 12, 2002

(54) System and method for transcoding

(76) Inventor: Royal O'Brien, Jacksonville, FL (US)

Correspondence Address: MARK J. YOUNG, 50 N. LAURA STREET, SUITE 3300, JACKSONVILLE, FL, 32202, US

(21) Appl. No.: 10/039,440

(22) Filed: Oct. 19, 2001

Related U.S. Application Data
(60) Provisional application No. 60/297,603, filed on Jun. 12, 2001.

(51) Int. Cl. H04N 7/12

(52) U.S. Cl. 375/240.12; 375/240.27

(57) ABSTRACT

A system and method for real-time transcoding of video data for transmission into a desired encoded format and bit-rate includes decoding, intra-transcoding, encoding and post-encoding processing. Decoding accommodates various input video data formats. Intra-transcoding processing includes deinterlacing, cropping, error correction and synchronization. Encoding accounts for post-codec processing of video data to remove compression errors before display. Post-encoding operations include encryption, packet identification and archiving.

### NON-PROVISIONAL APPLICATION

This application claims priority to U.S. Provisional Application No. 60/297,603, filed Jun. 12, 2001, the entire contents of which are hereby incorporated by reference herein.

### FIELD OF THE INVENTION

The present invention relates generally to transcoding. More particularly, the present invention relates to a system and method for real-time transcoding of video data for transmission in a desired encoded format and bit-rate.

### BACKGROUND

Various coding standards are applied to communicate video data. These standards include Motion Pictures Experts Group (“MPEG”)-1 for CD-ROM storage, MPEG-2 for DVD and DTV applications and H.261/263 for video conferencing. For distribution to the home, a growing consensus favors MPEG coding, currently MPEG-4 coding in particular. For other parts of the distribution chain, e.g., acquisition, post-production and archiving, there are a multitude of different formats.

These coding standards substantially compress video data to reduce the amount of bandwidth required for network transmission. As a complex distributed network, such as the Internet, must accommodate various transmission and load constraints, it is sometimes necessary or desirable to convert an already encoded video data stream before further transmission. Depending upon various constraints, changes to the bit-rate, resolution, format and syntax may be required. Bit-rate scaling may accommodate deficiencies in available bandwidth. Resolution changes may accommodate bandwidth limitations as well as limitations in an end-user's display device, such as processing, memory or display constraints. Formatting changes may also accommodate limitations in an end-user's display device. Syntax changes may ensure network adaptability and accommodate receiver compatibility requirements.

This process of converting between different coding bit-rates, resolutions, formats and syntax is known as transcoding, and may unnecessarily compromise the quality of the output or waste valuable bandwidth if performed without due care. For example, many transcoders indiscriminately encode unnecessary blank strips and pixel data outside of the display area (e.g., a television screen with an aspect ratio of 4:3), which are characteristic of certain encoded video data having a different aspect ratio than the display area.

Transcoding may also unnecessarily produce output that results in jagged motion. In encoding video streams, transcoders generally do not account for post-codec (coder-decoder) processing of video data, such as filtering to reduce noise and artifacts. Consequently, the quality or resolution of the encoded video may be set higher than needed, unnecessarily consuming valuable bandwidth.

Transcoders also often overlook operations required for optimally playing the video downstream. For example, transcoders typically do not deinterlace decoded data streams during an opportune interval, i.e., after decoding but before encoding the data streams for archiving and/or dissemination. Transcoders also generally fail to effectively synchronize decoded video and corresponding audio streams before encoding them for archiving and/or dissemination. Even a discrepancy in nanoseconds may lead to appreciable unsynchronization.

Another operation generally overlooked by transcoders is encryption. Encrypting output is essential for safeguarding the content from piracy.

While transcoding systems and methodologies are known in the art, none is believed to accommodate a plurality of inputs, while providing deinterlacing, cropping, synchronization and encryption capabilities, as well as a full range of encoding capabilities in various coding formats, all in real-time. Additionally, known transcoding systems are not tailored to optimize output for display on a system that implements post-codec processing to reduce or eliminate artifacts, noise and mosaic effects at a user's display.

### SUMMARY

The present invention provides a system and method for transcoding video data streams. The system and method of the present invention utilize cascade decoders and encoders to accommodate a plurality of input formats and provide for a plurality of output formats. The system and method of the present invention also provide deinterlacing, cropping, synchronization and encryption capabilities, all in real-time. Additionally, the system and method of the present invention optimize output for display on a system that implements post-codec processing to reduce or eliminate artifacts, noise and mosaic effects at a user's display.

An object of the present invention is to provide a system and method for transcoding video data streams.

Another object of the present invention is to provide a system and method for transcoding video data streams in real-time.

Another object of the present invention is to provide a transcoding system and method capable of accommodating a plurality of input formats and generating a plurality of output formats.

A further object of the present invention is to provide a transcoding system and method that deinterlaces video data streams after decoding but before encoding the data streams.

Still another object of the present invention is to provide a transcoding system and method that crops unnecessary video data from video data streams after decoding but before encoding the data streams.

An additional object of the present invention is to provide a transcoding system and method that precisely synchronizes video data and corresponding audio streams after decoding but before encoding the data streams.

Yet a further object of the present invention is to provide a transcoding system and method that encrypts encoded video data streams before archiving, transmitting or broadcasting the video data streams.

Still a further object of the present invention is to provide a transcoding system and method that optimizes output for display on a system that implements post-codec processing to reduce or eliminate artifacts, noise and mosaic effects at a user's display.

### DRAWINGS

These and other features, aspects and advantages of the present invention will become better understood with reference to the following description, appended claims, and accompanying drawings, where

FIG. 1 conceptually depicts a computer system for implementing a transcoder system and methodology in accordance with a preferred implementation of the present invention;

FIG. 2 is a block diagram conceptually depicting a transcoding system in accordance with a preferred implementation of the present invention;

FIG. 3 is a diagram that conceptually illustrates cropping in accordance with a preferred implementation of the present invention; and

FIG. 4 is a diagram that also conceptually illustrates cropping in accordance with a preferred implementation of the present invention.

### DETAILED DESCRIPTION

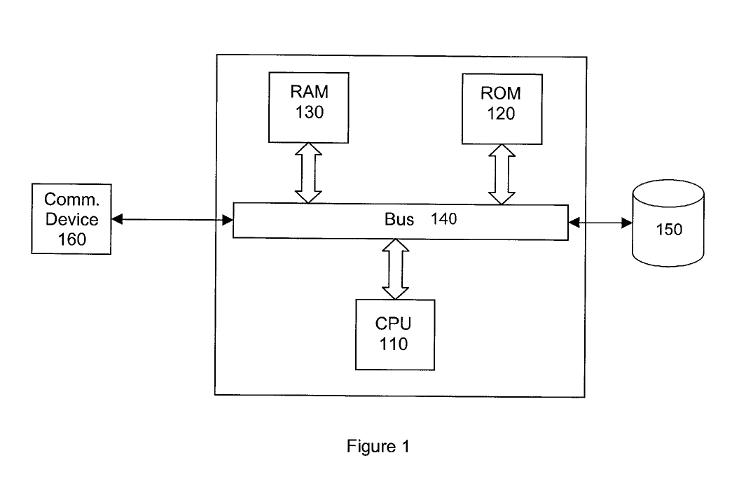

Referring to FIG. 1, an exemplary system for transcoding video data streams in accordance with the present invention preferably includes a bus 140 for communicating information, a central processing unit (CPU) 110, a read only memory (ROM) 120, random access memory (RAM) 130, a storage device 150, and a communications device 160. The storage device may include a hard disk, CD-ROM drive, tape drive, memory and/or other mass storage equipment. These elements are typically included in most computer systems and particularly computer servers, and the aforementioned system is intended to represent a broad category of systems capable of being programmed to perform transcoding in accordance with a preferred implementation of the present invention. Of course, the system may include fewer, different and/or additional elements, provided it is capable of transcoding in accordance with the present invention. For example, the system may include multiple CPUs, a display device, and various input and output devices. Additionally, the system may alone perform transcoding or operate in a distributed environment to accomplish transcoding in accordance with a preferred implementation of the present invention.

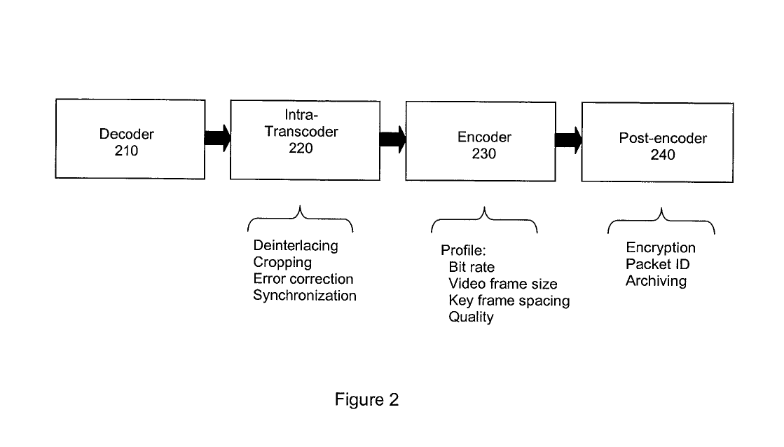

Referring to FIG. 2, a preferred implemenation of a transcoder system in accordance with a preferred implementation of the present invention includes a decoder 210, an intra-transcoder 220, an encoder 230, and a post-encoder 240. These elements are preferably comprised of computer software, though they may also be implemented as firmware or hardware.

The decoder receives and decodes an input video data stream that has previously been encoded. The type of decoder depends primarily upon the format of the input stream. Various hardware and software decoders are known in the art and available commercially for MPEG and H.261/263 encoded video data streams, as well as other encoding formats known in the art. The transcoder of the present invention may employ a single decoder suitable for a specific type of input stream, or a plurality of decoders automatically or manually selectable to accommodate a variety of types of input streams.

The video decoding process is generally the inverse of the video encoding process and is employed to reconstruct a motion picture sequence from a compressed and encoded bitstream. The data in the bitstream is decoded according to a syntax that is defined by the data compression algorithm. The decoder must first identify the beginning of a coded picture, identify the type of picture, then decode each individual macroblock within a particular picture.

When encoded video data is transferred to a video decoder, the encoded video data is typically received and stored in a channel buffer. The data is then retrieved from the channel buffer for performing the decoding process.

For example, when an MPEG decoder receives the encoded stream, the MPEG decoder reverses MPEG encoding operations. Thus, an MPEG decoder performs inverse scanning to remove zigzag ordering, inverse quantization to de-quantize the data, and inverse DCT (discrete cosine transformation) to convert the data from a frequency domain back to a pixel domain. The MPEG decoder also performs motion compensation using transmitted motion vectors to re-create temporally compressed frames.

An MPEG stream generally includes three types of pictures, referred to as an Intra (I) frame, a Predicted (P) frame, and a Bi-directional Interpolated (B) frame. The I (intra) frames contain the video data for the entire frame of video and are typically placed every 10 to 15 frames. Intraframes are generally only moderately compressed. Predicted frames are encoded with reference to a past frame, i.e., a prior Intraframe or Predicted frame. Thus P frames only include changes relative to prior I or P frames. In general, P frames receive a fairly high amount of compression and are used as references for future P frames. Thus, both I and P frames are used as references for subsequent frames. Bi-directional pictures include the greatest amount of compression and require both a past and a future reference in order to be encoded. Bi-directional frames are generally not used as references for other frames.

When frames are received which are used as references for other frames, such as I or P frames, these frames are decoded and stored in memory. When a reconstructed frame is a reference or anchor frame, such as an I or a P frame, the reconstructed frame replaces the oldest stored anchor frame and is used as the new anchor for subsequent frames.

When a temporally compressed or encoded frame is received, such as a P or B frame, motion compensation is performed on the frame using the neighboring decoded I or P reference frames, also called anchor frames. The temporally compressed or encoded frame, referred to as a target frame, will include motion vectors which reference blocks in neighboring decoded I or P frames stored in the memory. The MPEG decoder examines the motion vector, determines the respective reference block in the reference frame, and accesses the reference block pointed to by the motion vector from the memory.

To reconstruct a B frame, the two related anchor frames or reference frames must be decoded and available in a memory, referred to as the picture buffer. This is necessary since the B frame was encoded relative to these two anchor frames. Thus the B frame must be interpolated or reconstructed using both anchor frames during the reconstruction process.

After all of the macroblocks have been processed by the decoder, the picture reconstruction (i.e., decoding) is complete.

The MPEG standard does not dictate implementations for encoders and decoders. Although the various encoding and decoding methods theoretically yield similar end results, preferred methods conform to IEEE Standard 1180-1990 and have minimal implementation complexity.

The present invention works equally as well with raw digital video data, i.e., data that has not been encoded. In such case, the decoding operation may be entirely bypassed, or be viewed as a pass-through. If the video is in the form of analog signals, it should be digitized for utility with the present invention. In such a case the so-called “decoded” data or video data stream may be the same as the input data or video data stream.

The present invention may be configured to work with a single type of input data stream (e.g., raw digital video data, MPEG-2 encoded, H.261/.263 encoded). Alternatively, the present invention may automatically detect the type of input stream and apply a decoder that corresponds to the input stream, assuming decoding is necessary.

After passing through the decoder, assuming decoding is necessary, the video data stream enters the intra-transcoder, which processes the video data before it is encoded for further dissemination or archiving. Intra-transcoder processing operations may include deinterlacing, cropping, artifact correction, synchronization, and/or any other processing steps designed to facilitate delivery, or enhance or tailor the output stream. Output from the intra-transcoder is considered intra-transcoded.

As part of the intra-transcoder, interlaced data may be deinterlaced, using any applicable deinterlacing methodology that may be known in the art or preferably the deinterlacing methodology described below. Interlaced video alternately groups either odd or even scan lines into consecutive fields of a motion picture sequence so that a pair of fields in interlaced video comprises one full resolution picture. Progressive video contains the full complement of scan lines for each field of a motion picture sequence.

Progressive video is desirable for many reasons. Progressive displays have fewer visual artifacts, such as line crawl on diagonal edges of the image and twitter on horizontal edges of the image. Tasks, such as frame rate conversion, spatial scalability (picture zooming) and digital special effects, are simpler with progressive video. Thus converting interlaced video to progressive video is a desirable objective.

The deinterlacing operation preferably entails calculating and/or reinserting either the odd or even scan line picture elements (pixels) that are dropped from alternate fields of interlaced video, and removing artifacts before feeding the progressive video into the encoder. When a picture sequence contains moving objects or the scene is being panned, merging may cause visual artifacts. For example, if a picture sequence contains an object with a vertical edge moving in a horizontal direction. Deinterlacing by merging may produce a comb effect along the moving edge of the object. Adjusting the interpolated or inserted pixel based upon the values of the pixels above and below the interpolated or inserted pixel may reduce or eliminate such artifacts. However, doing so may unnecessarily compromise the resolution for still portions. As a video sequence typically contains both objects in motion and static pictures, either in different regions of the field or at different times in the field sequence, a deinterlacing technique that varies interpolated or inserted pixels according to local motion content is preferred.

Motion detection is preferably accomplished by detecting inter-frame color differences in the neighborhood of the pixel being interpolated. When the difference is low, the measure of motion is small. When the difference is high, greater motion is assumed. Preferably the deinterlacing operation works with both RGB and YUV data. In the case of RGB, the deinterlacer may utilize each color component of red, green and blue to detect motion. In the case of YUV, the deinterlacer may use only the color differential components of U and V to detect motion.

Where the color difference exceeds a threshhold value, the inserted pixel value is adjusted based upon the values of the pixels above and below the inserted pixel. The adjustment may entail averaging or blending. For example, the inserted pixel value may equal:

P_{inserted}=X·P_{above}+Y·P_{original}+Z·P_{below}

Where:

X+Y+Z=1

P_{inserted} equals the RGB or UV pixel value components for the inserted pixel,

P_{above} equals the RGB or UV pixel value components for the pixel above the inserted pixel, and

P_{below} equals the RGB or UV pixel value components for the pixel below the inserted pixel.

Values of X, Y and Z that have been found to produce satisfactory results include, X=½, Y=0, and Z=½; X=⅓, Y=⅓, Z=⅓; as well as X=¼, Y=½, and Z=¼, with the last set of X, Y and Z values being generally preferred.

As part of the intra-transcoder, video data may be cropped to accommodate a desired output aspect ratio and eliminate extraneous data. The display area of a television receiver typically has either a display aspect ratio (width to height) of 4:3 or 16:9, the latter of which is conventionally considered a “wide screen” format. These ratios are relatively standard, although other ratios are known as well. Movie productions are available in widely varying aspect ratios.

To show a 4:3 video on a 16:9 display unit, or to show a 16:9 signal on a 4:3 display unit, either less than all of the display unit area is used, or the video information is altered. The received picture can be zoomed to fill the screen in one dimension, with portions in the other dimension removed from the signal. For example, top and bottom portions of a 4:3 signal can be cropped, with the remainder filling a 16:9 format area, or side portions of a 16:9 signal can be cropped, with the remainder filling a 4:3 area.

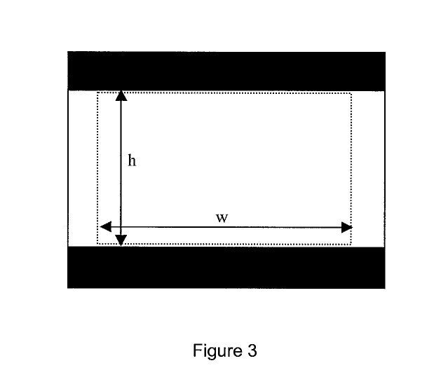

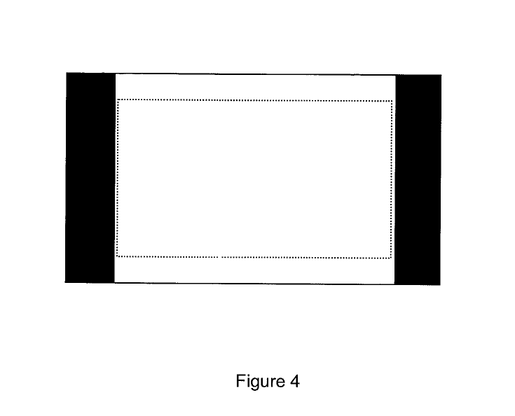

Often, video data streams include data representative of black bands which appear along the top and bottom or sides of a picture to fill a screen. For example, in a letterbox format, 16:9 images are displayed on a 4:3 display with 12½% black bands at the top and bottom, as conceptually shown in FIG. 3. In a pillar-box format, 4:3 images may be presented on a 16:9 display with 12½% black bands along the sides, as conceptually shown in FIG. 4. Similar black bands may be introduced into video data when mapping motion pictures having various aspect ratios to a desired output aspect ratio. By doing so, the entire picture is displayed, i.e., no portion has been cropped out.

However, there are serious drawbacks in displaying the black bands. Even though they are black, the bands still emit some luminescence, which may distract viewers. Additionally, the bands consume a significant portion of the display. Thus, many viewers may find the black bands annoying.

Data representative of black bands also consume valuable bandwidth during transmission. Combined, black bands may comprise approximately 25% of the viewing area, and an appreciable portion of the video data stream.

In a preferred implementation of the present invention, data representative of black bands are detected and removed from the video stream and, if necessary, the video image data is cropped to produce an output having a desired aspect ratio without distorting the remaining image data. Thus, for example, referring to FIG. 3, to generate a motion picture having an aspect ratio of 4:3 from a letterbox format, data representative of the black bands are preferably removed, and data representative of pixels outside of the dotted lines are removed. The dotted lines define a rectangular viewing area having a center in common with the original letterbox image. The height (h) of the viewing area preferably equals the height of the original image without the black bands, though other heights may be used, and the width (w) of the viewing area preferably equals the product of the height and 4/3. The remaining data will generate a picture suitable for full display on a 4:3 display unit. The excised black bands will no longer consume valuable bandwidth or distract viewers. While some portions of the motion picture are lost, the excised portions comprise outer edges, which are typically not a focal point of a scene.

A similar process may be applied to adjust pillar-box input for viewing on a 16:9 display unit. Referring to FIG. 4, data representative of the black bands are preferably removed, and data representative of pixels outside of the dotted lines are removed. The dotted lines define a rectangular viewing area having a center in common with the original pillar-box image. The width (w) of the viewing area preferably equals the width of the original image without the black bands, though other widths may be used, and the height (h) of the viewing area equals the product of the width and 9/16. The remaining data will generate a picture suitable for full display on a 16:9 display unit.

In an alternative implementation within the scope of the present invention, only portions of the black bands may be eliminated. For example, in the case of a letterbox image, the top half of the top black band and bottom half of the bottom black band may be removed. This would reduce the adverse effects of the black bands, while reducing the amount of the original motion picture that is lost in cropping. In such case the height of the viewing area may equal the height of the original viewing area with the remaining portions of the black bands, and the width may equal the product of the height and 4/3.

As another part of the intra-transcoder, separated video and audio data streams are preferably synchronized before they are fed into the encoder. Because even a discrepancy in nanoseconds can lead to appreciable synchronization errors, preferably the exact frame rate of the input as decoded is passed on to the encoder.

The intra-transcoder may also implement processing that uses post-decompression corrective methodologies known in the art, such as the processes disclosed in U.S. Pat. No. 6,178,205, to remove artifacts and reduce noise introduced in the original encoding process. Corrective processing can be particularly useful in situations where the video data stream is being transcoded to a higher bit-rate for transmission over a network connection with greater available bandwidth than that available to the input encoded video data stream.

After passing through the intra-transcoder, the video data stream then passes through the encoder where it is encoded. The encoder must be able to produce video data stream output having a desired format, bit rate and attributes. In a preferred implementation of the present invention, an MPEG-4 codec (coder-decoder) is used such as Windows Media MPEG-4 Video v3 for encoding video. For encoding audio, Windows Media Audio v8 may be used. Encoder output is considered encoded and intra-transcoded.

Using a suitable encoding profile is a crucial step in successful transcoding. The encoding profile preferably includes specifications for bit rate, frame size, key frame spacing and quality. As the present invention contemplates generating output for display on a system that implements post-codec processing to reduce or eliminate artifacts, noise and mosaic effects at a user's display, the preferred output is a low bandwidth video data stream. Though the output will include DCT encoding errors in the video frames, post-rendering processing may substantially reduce these errors and help restore the original picture quality.

The bit rate defines the rate of transmission. A high bit rate typically requires less compression, which yields better quality of video. A low bit rate generally requires more compression, which compromises the quality of the video. In a preferred implementation of the present invention the bit rate is preferably selected to achieve a desired compression ratio, such as 28:1 to 32:1.

The video frame size is another key profile setting. Different frame sizes accommodate different aspect ratios. Additionally, different sizes consume different bandwidth. For example, a small video frame size may lower the bit rate, but may compromise image quality. In contrast, full video size, e.g., 640×480 pixels, would substantially increase the bit rate. In a preferred implementation of the present invention the bit rate is preferably selected to achieve marginal output frame sizes determined by the aspect ratio of the frames being encoded.

Key frame spacing defines approximately how many key frames should be present in one second of encoded video. A key frame (e.g., an I frame) is a frame that does not depend on a previous or next frame while decoding. The number of key frames per second is preferably derived based on the motion nature of the video content, with high-speed action and fast-changing scenes warranting more key frames per second to preserve picture quality. In a preferred implementation of the present invention, the key frame spacing is selected to provide a key frame approximately every 4 seconds.

Quality defines a tradeoff between image and motion quality, with 0 representing low quality and smooth motion and 100 for high quality and jagged motion. As the present invention contemplates enhancing the quality of the video downstream, in a preferred implementation of the present invention this value is set at approximately 70.

After encoding, post-encoder operations may be performed. These operations may include encryption, packet identification and archiving. Encryption safeguards the output from unauthorized viewing and reproduction. Before transmitting the encoded video, preferably each key frame in the encoded video stream is encrypted with an encryption key that is dynamically generated from the video stream itself, using encryption methodologies known in the art. As an added precaution, the encryption key may be changed for each key frame, also using encryption methodologies known in the art. Furthermore, the entire output, including encrypted key frames, may be further encrypted using another encryption algorithm and key. Even keys transmitted to the user may be encrypted to reduce the risk of piracy. An authorized user, having the necessary software, encryption keys and/or authenticated hardware (i.e., hardware having a certain access code, such as an approved electronically verifiable serial number) may decrypt the output.

Packet identification attaches a sequential packet id with each output packet produced by the system and method of the present invention. Thus, the user's system may receive packets and store them in a buffer until there is enough data to decode the video stream. This helps identify missing packets and buffer enough data before playing. Preferably, the packet size is selected based on network capacity, and the maximum packet size that can efficiently be sent over the current network.

Archiving entails saving the encoded output to a local file. Preferably, archiving may be performed while the output is broadcast. Large numbers of archived transcoded video may be stored on servers for delivery upon request, without the need to transcode the video again.

The invention summarized above and defined by the enumerated claims may be better understood by referring to the following detailed description, which should be read in conjunction with the accompanying drawing. This detailed description of a particular preferred embodiment, set out below to enable one to practice the invention, is not intended to limit the enumerated claims, but to serve as a particular example thereof. Those skilled in the art should appreciate that they can readily use the concepts and specific embodiment disclosed as a basis for modifying or designing other methods and systems for carrying out the same purposes of the present invention. Those skilled in the art should also realize that such equivalent methods and systems do not depart from the spirit and scope of the invention in its broadest form.

We claim:

1. A method of transcoding an input video data stream to achieve a desired output video data stream, said transcoding method comprising:
decoding the input video data stream,
intra-transcoding the decoded video data stream,
encoding the intra-transcoded video data stream, and
post-encoding the encoded intra-transcoded video data stream.

2. The method according to claim 1 wherein the step of intra-transcoding further comprises deinterlacing the video data stream.

3. The method according to claim 1 wherein the step of intra-transcoding further comprises cropping the video data stream.

4. The method according to claim 1 wherein the decoded video data stream includes compression errors and the step of intra-transcoding further comprises removing the compression errors from the decoded video data stream.

5. The method according to claim 1 wherein the step of intra-transcoding further comprises synchronizing the video data stream.

6. The method according to claim 1 wherein the step of encoding further comprises applying an encoding profile to achieve the desired output video data stream.

7. The method according to claim 6 wherein the step of applying an encoding profile to achieve the desired output video data stream further comprises setting a bit rate to achieve the desired output video data stream.

8. The method according to claim 6 wherein the step of applying an encoding profile to achieve the desired output video data stream further comprises setting a video frame size to achieve the desired output video data stream.

9. The method according to claim 6 wherein the step of applying an encoding profile to achieve the desired output video data stream further comprises setting a key frame spacing to achieve the desired output video data stream.

10. The method according to claim 6 wherein the step of applying an encoding profile to achieve the desired output video data stream further comprises setting a quality to achieve the desired output video data stream.

11. A system for transcoding an input video data stream to a desired output video data stream, said transcoding system comprising:
means for decoding the input video data stream
means for intra-transcoding the decoded video data stream,
means for encoding the intra-transcoded video data stream, and
means for post-encoding the encoded intra-transcoded video data stream.

12. The system according to claim 11 wherein the means for intra-transcoding further comprises means for deinterlacing the video data stream.

13. The system according to claim 11 wherein the means for intra-transcoding further comprises means for cropping the video data stream.

14. The system according to claim 11 wherein the decoded video data stream includes compression errors and the means for intra-transcoding further comprises means for removing the compression errors from the decoded video data stream.

15. The system according to claim 11 wherein the means for intra-transcoding further comprises means for synchronizing the video data stream.

16. The system according to claim 11 wherein the means for encoding further comprises means for applying an encoding profile to achieve the desired output video data stream.

17. The system according to claim 16 wherein the means for applying an encoding profile to achieve the desired output video data stream further comprises means for setting a bit rate to achieve the desired output video data stream.

18. The system according to claim 16 wherein the means for applying an encoding profile to achieve the desired output video data stream further comprises means for setting a video frame size to achieve the desired output video data stream.

19. The system according to claim 16 wherein the means for applying an encoding profile to achieve the desired output video data stream further comprises means for setting a key frame spacing to achieve the desired output video data stream.

20. The system according to claim 16 wherein the means for applying an encoding profile to achieve the desired output video data stream further comprises means for setting a quality to achieve the desired output video data stream.
